(19) United States
(12) Patent Application Publication
(10) Pub. No.: US 2026/0145606 A1
(43) Pub. Date: May 28, 2026

(54) HORIZONTAL LOADING AND UNLOADING STRUCTURE OF CARGO VEHICLES

(71) Applicant: SPEED FLOOR CO.,LTD, Incheon (KR)

(72) Inventors: Hyun Jin HONG, Incheon (KR); suk min HONG, Incheon (KR)

(73) Assignee: SPEED FLOOR CO.,LTD, Incheon (KR)

(21) Appl. No.: 18/962,614

(22) Filed: Nov. 27, 2024

(51) Int. Cl. B60P 1/38; B60J 5/10; E05D 15/40

(52) U.S. Cl. CPC B60P 1/38; B60J 5/108; E05D 15/403

(57) ABSTRACT

The present disclosure relates to a horizontal loading and unloading structure of cargo vehicles, which includes at least: a drive chain belt configured to include mutually separated chains, a passive cover joined to the drive chain belt in a planar configuration, a drive shaft joined to a gear of the drive chain belt at a first stage of the base plate, and transmitting a driving force in a first direction to an upper part of the drive chain belt during a loading process or transmitting the driving force in a second direction to a lower part of the drive chain belt during an unloading process, a passive shaft joined to the passive cover at a second stage of the base plate, and a driver providing the driving force in the first direction or in the second direction to the drive shaft.

### TECHNICAL FIELD

The present disclosure relates to a loading and unloading structure of cargo vehicles, and more specifically, relates to a horizontal loading and unloading structure of cargo vehicles which may automatically horizontally loading a cargo into and unloading a cargo from a loading space of the cargo vehicles.

### BACKGROUND ART

The cargo vehicle refers to a vehicle which aims to transport various materials. A driving operation of the cargo vehicle may be largely divided into a loading operation, an unloading operation, and a driving operations. The loading operation and the unloading operation may be divided into operations using manpower and operations using equipment, facilities, and tools. A vehicle loading operation is an operation for loading a cargo onto a vehicle in a transportable state, and a vehicle unloading operation is an operation for putting the cargo loaded on a transporter (vehicle) down to a loading location in a workplace. The driving operation is an operation for checking a transport record on which a type, a quantity, and a destination of the cargo are recorded, and for transporting the cargo to the destination in view of a loading height, weight, or the like of the cargo loaded by using the cargo vehicle.

According to a recent industrial accident status, accident cases occur most frequently during the loading and unloading operations of the cargo vehicles. For example, in many cases, the cargos fall down while the cargos are loaded, and bodies of workers are injured due to excessive cargo loading operations. In order to improve this status, it is desirable to develop a technology for automating loading and unloading operations.

### PRIOR ART DOCUMENT

### Patent Document 1

Korean Patent No. 10-2300767 (registered on Sept. 6, 2021)

### DETAILED DESCRIPTION OF INVENTION

### Technical Problems

One embodiment of the present disclosure is to provide a horizontal loading and unloading structure of cargo vehicles which may automatically horizontally loading a cargo into and unloading a cargo from a loading space of the cargo vehicles.

One embodiment of the present disclosure is to provide a horizontal loading and unloading structure of cargo vehicles which may minimize a volume loss rate of a loading space by adopting a configuration in which a chain and a belt are joined, the belt is exposed on an upper part of a base plate to be in direct contact with a cargo, and the belt is horizontally moved on the base plate to automatically load and unload the cargo.

One embodiment of the present disclosure is to provide a horizontal loading and unloading structure of cargo vehicles which may stably perform loading and unloading operations of cargos by pulling a belt through chain rotation.

### Technical Solution

In embodiments, a horizontal loading and unloading structure of cargo vehicles includes a base plate, a drive chain belt configured to include mutually separated chains, at least a portion of which is always exposed to an upper part on the base plate, a passive cover joined to both ends of the drive chain belt in a planar configuration, at least a portion of which is exposed to a lower part to surround the base plate together with the drive chain belt, and configured to have a length of 80% to 120% of a length of the drive chain belt, a drive shaft joined in gear to the drive chain belt at a first stage of the base plate, and transmitting a driving force in a first direction to an upper part of the drive chain belt during a loading process or transmitting the driving force in a second direction to a lower part of the drive chain belt during an unloading process, a passive shaft closely joined to the passive cover at a second stage of the base plate, and passively operated in accordance with a movement of the passive cover, and a driver providing the driving force in the first direction or in the second direction to the drive shaft.

In embodiments, the horizontal loading and unloading structure of cargo vehicles may further include a back door that maximizes a loading space by exposing at least a portion of the passive shaft outward of a rear surface of the loading space and coming into contact with a specific point of the base plate to form the loading space.

The back door may form a bending portion in an upper part, may rotate in an upward direction through a rotary shaft joined to an end of the upper part to open the loading space, and may rotate in a downward direction to close the loading space.

The drive chain belt may be configured to include a plurality of chain belts each engaged with the gear, may be operated while at least a portion of the chain belts is always exposed to the upper part of the base plate during a process of providing the driving force in the first direction or in the second direction, and may fixedly join the bulkhead plate to an upper exposed portion connected to the passive cover.

The drive shaft may form the gear along a perimeter in a joining region of the drive chain belt, may axially move to the lower part during the loading process to transmit the driving force in the first direction to the upper part, and may axially move to the upper part during the unloading process to transmit the driving force in the second direction to the lower part.

The passive shaft may be disposed outside the loading space of the cargo vehicle, and is exposed outward of the loading space regardless of whether the back door is opened or closed.

The driver may move the drive shaft to the upper part or to the lower part by a specific angle during a process of initially providing the driving force, and may provide a relatively strong driving rotational force.

In embodiments, the horizontal loading and unloading structure of cargo vehicles may further include a chain belt guide disposed along a movement path of the drive chain belt in a lower part of the base plate, and internally accommodating the drive chain belt to prevent sagging of the drive chain belt.

### Effect of Invention

The disclosed technology may have the following advantageous effects. However, it does not mean that a specific embodiment must include all of the following advantageous effects or must include only the following advantageous effects. Therefore, the scope of the disclosed technology should not be construed as being limited thereby.

The horizontal loading and unloading structure of the cargo vehicles according to one embodiment of the present disclosure may automatically horizontally load the cargo into and unload the cargo from the loading space of the cargo vehicles.

The horizontal loading and unloading structure of the cargo vehicles according to one embodiment of the present disclosure may minimize a volume loss rate of the loading space by adopting a configuration in which a chain and a belt are joined, the belt is exposed on an upper part of a base plate to be in direct contact with a cargo, and the belt is horizontally moved on the base plate to automatically load and unload the cargo.

The horizontal loading and unloading structure of the cargo vehicles according to one embodiment of the present disclosure may stably perform loading and unloading operations of cargos by pulling the belt through chain rotation.

### BRIEF DESCRIPTION OF THE DRAWING

FIG. 1 is a perspective view showing a horizontal loading and unloading structure of cargo vehicles according to one embodiment of the present disclosure.

FIG. 2 is a cross-sectional view showing the horizontal loading and unloading structure in FIG. 1.

FIG. 3 is a diagram showing a main part of a cargo vehicle in FIG. 1.

FIG. 4 is a diagram for describing a joining structure of a drive chain belt and a passive cover in FIG. 1.

FIGS. 5A-5C are diagrams showing a lower exposed portion to which the drive chain belt and the passive cover in FIG. 4 are connected.

FIGS. 6A and 6B are diagrams showing a fastening state of the drive chain belt and a drive shaft in FIG. 1.

FIG. 7 is a diagram showing an embodiment of a cargo vehicle to which the horizontal loading and unloading structure according to the present disclosure is applied.

### BEST MODE FOR CARRYING OUT THE INVENTION

Since description of the present disclosure is merely an embodiment for structural and functional description, the scope of the rights of the present disclosure should not be construed as being limited by embodiments described herein. That is, since the embodiments may be modified in various ways, and may have various forms, the scope of the rights of the present disclosure should be understood to include equivalents that may realize the technical idea. In addition, it does not mean that a specific embodiment must include all of an object or advantageous effects presented in the present disclosure or must include only the advantageous effects. Therefore, the scope of the rights of the present disclosure should not be understood as being limited thereby.

Meanwhile, meanings of terms described in the present application should be understood as follows.

Terms of “first”, “second”, and the like are intended to distinguish one component from another component, and the scope of the rights should not be limited by these terms. For example, a first component may be referred to as a second component, and similarly, the second component may also be referred to as the first component.

When it is described that a certain component is “connected” to another component, it should be understood that the certain component may be directly connected to the other component, but still another component may exist therebetween. On the other hand, when it is described that a certain component is “directly connected” to another component, it should be understood that still another component does not exist therebetween. Meanwhile, other expressions for describing a relationship between components, that is, “between” and “directly between” or “adjacent to” and “directly adjacent to” should be construed in the same way.

A singular expression should be understood to include a plural expression unless the context clearly indicates otherwise, and terms of “including” or “having” are intended to specify the presence of embodiment features, numbers, steps, operations, components, parts, or combination thereof, and should be understood not to exclude a possibility of the presence or addition of one or more other features, numbers, steps, operations, components, parts, or combinations thereof.

In respective steps, identifiers (for example, a, b, c, and the like) are used for convenience of description, and the identifiers do not describe the order of the respective steps, and the respective steps may occur in an order different from a described order unless the context clearly indicates a specific order. That is, the respective steps may occur in an order the same as the described order, may be substantially simultaneously, performed, or may be performed in the opposite order.

Unless otherwise defined, all terms used herein have the same meaning as those commonly understood by a person of ordinary skill in the art to which the present disclosure belongs. Terms defined in commonly used dictionaries should be construed as having a meaning consistent with the contextual meaning of the relevant art, and should not be construed as having an idealized or overly formal meaning unless explicitly defined in the present application.

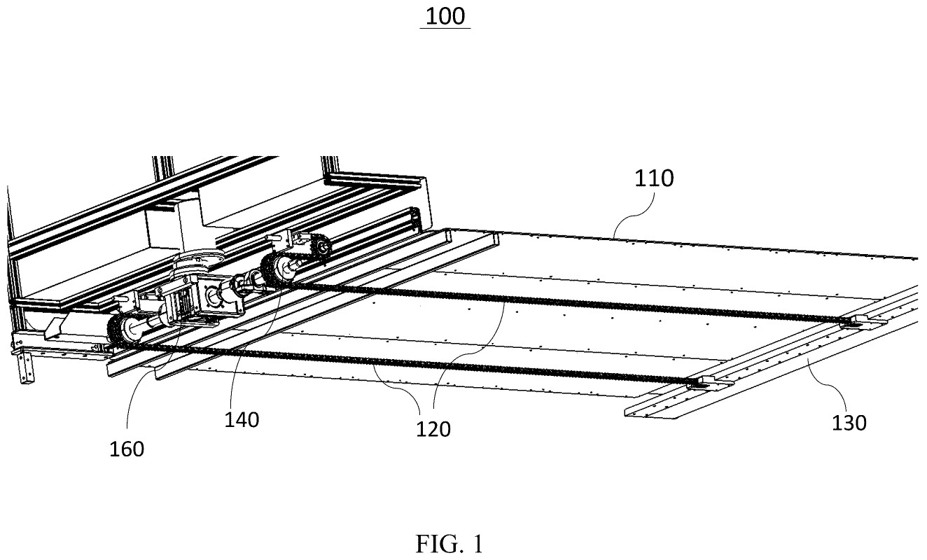

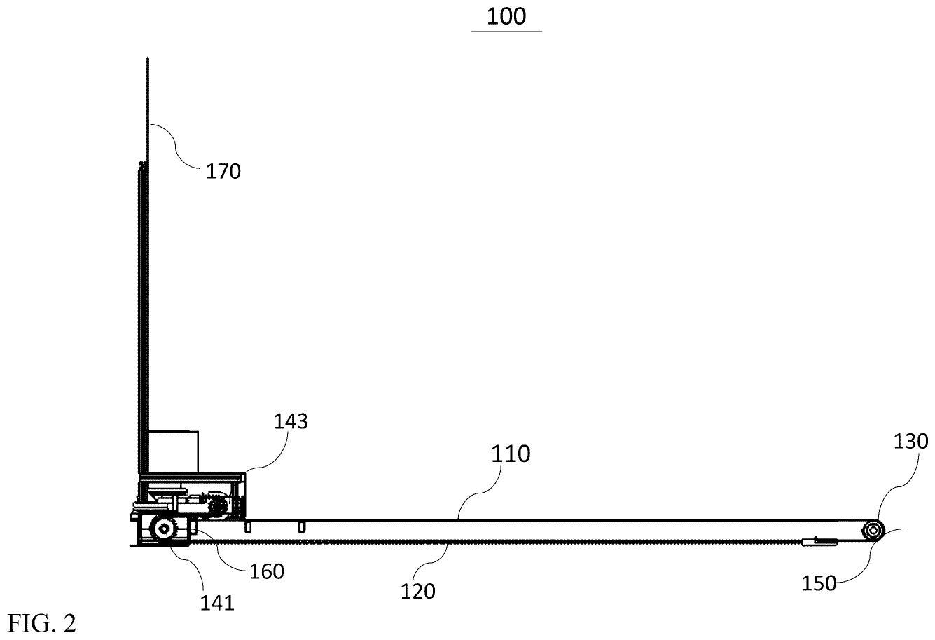

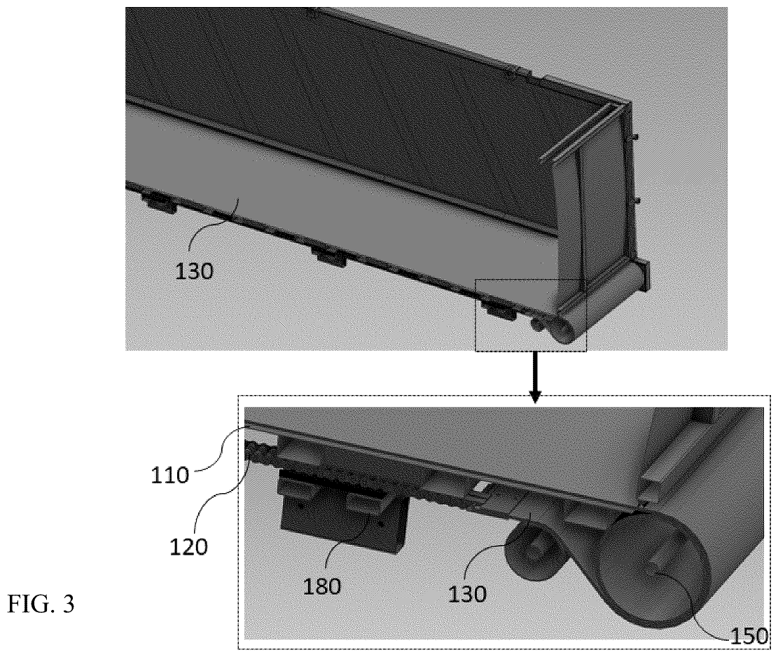

FIG. 1 is a perspective view showing a horizontal loading and unloading structure of cargo vehicles according to one embodiment of the present disclosure, FIG. 2 is a cross-sectional view showing the horizontal loading and unloading structure in FIG. 1, and FIG. 3 is a diagram showing a main part of the cargo vehicle in FIG. 1.

Referring to FIGS. 1 to 3, a horizontal loading and unloading structure (100) of cargo vehicles is installed so that a cargo is automatically loaded onto and unloaded from a loading space of the cargo vehicles, and for this purpose, the horizontal loading and unloading structure (100) may include a base plate (110), a drive chain belt (120), a passive cover (130), a drive shaft (140), a passive shaft (150), a driver (160), and a control unit (not shown).

The base plate (110) is formed in a flat plate shape that forms a bottom surface of the loading space in the cargo vehicle. In the cargo vehicle, a front side is provided with a driver's seat for a driver to ride in, and a rear side is provided with a loading box internally having the loading space to load the cargo. The base plate (110) corresponds to a bottom of the loading box, and the horizontal loading and unloading structure of the present disclosure may be installed to minimize a volume loss of the loading space of the loading box.

The drive chain belt (120) is configured to include mutually separated chains, at least a portion of which is always exposed to an upper part on the base plate (110). In one embodiment, the drive chain belt (120) is disposed on the base plate (110) with a constant length, and rotates and moves along the base plate (110). Here, the drive chain belt (120) is configured to include a plurality of chain belts, and is operated while at least a portion is always exposed to the upper part of the base plate (110). Here, the drawing shows that the drive chain belt (120) has two chain belts disposed parallel to the base plate (110). However, the configuration is not necessarily limited thereto, and a length and the number of the chain belts may be appropriately determined depending on a length and a width of the base plate (110) forming a bottom surface of the loading space and depending on a type or a loading load of the cargo.

The passive cover (130) is joined to both ends of the drive chain belt (120) in a planar configuration, at least a portion being exposed to a lower part to surround the base plate (110) together with the drive chain belt (120), and is configured to have a length of 80% to 120% of a length of the drive chain belt (120). That is, the passive cover (130) may be configured to be the same as the length of the drive chain belt (120) or to be shorter or longer than the length of the drive chain belt (120) within a range of 20%. For example, when the length of the drive chain belt (120) is 3,760 mm, based on a one ton cargo vehicle, the passive cover (130) may be configured to have the length of 3,008 mm to 4,512 mm. Since a force of the drive chain belt (120) varies depending on the length, the length of the passive cover (130) is set to 80% to 120% of the length of the drive chain belt (120) so that the passive cover (130) smoothly moves along the drive chain belt (120).

The horizontal loading and unloading structure (100) of the cargo vehicles according to the present disclosure is configured so that the drive chain belt (120) and the passive cover (130) have an approximately half joining structure. Therefore, the structure may be simplified, a weight may be reduced, and an occupied area of an installation space may be minimized.

In one embodiment, the passive cover (130) is linked to the drive chain belt (120) on both sides, and moves along the drive chain belt (120). The passive cover (130) may horizontally move on the base plate (110) in accordance with the rotation of the drive chain belt (120), and may load the cargo into and unload the cargo from the loading space. Here, the passive cover (130) may be formed of a plate member having an elastic rubber material, but is not necessarily limited thereto. The passive cover (130) may be formed of a flexible material that moves along the drive chain belt (120) so that at least a portion is exposed to the lower part of the base plate (110) and at least another portion is exposed to the upper part of the base plate (110). The passive cover (130) may have a structure exposed to the upper part of the base plate (110) and coming into direct contact with the cargo.

In one embodiment, the drive chain belt (120) and the passive cover (130) may be joined via the bulkhead plate (170). That is, the bulkhead plate (170) may be fixedly joined to an upper exposed portion to which the drive chain belt (120) and the passive cover (130) are connected. The bulkhead plate (170) may be configured to include an upper plate and a lower plate, and may be vertically mounted on the loading space of the cargo vehicle to form a bulkhead. The bulkhead plate (170) may be moved in the same direction as the passive cover (130) along the drive chain belt (120) in such a manner that an upper exposed end of the drive chain belt (120) is joined to one side of the lower plate and an upper exposed end of the passive cover (130) is joined to the other side of the lower plate. In this case, the bulkhead plate (170) may support the cargo loaded and unloaded on the passive cover (130) in a loading and unloading direction so that the cargo is stably loaded and unloaded.

As shown in FIG. 3, the chain belt guide (180) may be disposed in the lower part of the base plate (110) along a movement path of the drive chain belt (120). The chain belt guide (180) may internally accommodate the drive chain belt (120) to prevent sagging of the drive chain belt (120). The chain belt guide (180) may guide the movement of the passive cover (130) moving along the drive chain belt (120) by preventing sagging caused by a load.

The drive shaft (140) is joined in gear to the drive chain belt (120) at a first stage of the base plate (110), transmits a driving force in a first direction to the upper part of the drive chain belt (120) during a loading process, or transmits the driving force in a second direction to the lower part of the drive chain belt (120) during an unloading process. The drive shaft (140) may provide the driving force in the first direction or in the second direction in such a manner that a plurality of chain belts of the drive chain belt (120) are respectively fastened in gear to the drive shaft (140). In one embodiment, the drive shaft (140) is configured to include a pair of gears, and the drive chain belt (120) passes between the pair of gears as the gears rotate. Specifically, the drive shaft (140) may include a lower gear (141) connected to the driver (160) and transmitting the driving force provided by the driver (160), and an upper gear (143) receiving the driving force through the lower gear (141) to move the drive chain belt (120). The lower gear (141) is fixedly joined to the first stage of the base plate (110). The upper gear (143) may be operated while always being exposed to the upper part of the base plate (110), and may be fixedly joined to the bulkhead plate (170). The lower gear (141) is configured to have a larger diameter than the upper gear (143).

In the drive shaft (140), the lower and upper gears (141 and 143) are formed along a perimeter in a joining region of the drive chain belt (120). The drive shaft (140) may transmit the driving force in the first direction to the upper gear (143) through the lower gear (141) during a loading process, and may transmit the driving force in the second direction to the upper gear (143) through the lower gear (141) during an unloading process. In this case, the upper gear (143) may receive the driving force in the first direction or in the second direction, and may move the drive chain belt (120) while rotating in the corresponding direction.

The passive shaft (150) is closely joined to the passive cover (130) at the second stage of the base plate (110), and is passively operated in accordance with the movement of the passive cover (130). The passive shaft (150) may be disposed outside the loading space of the cargo vehicle, and may be exposed outward of the loading space regardless of whether the back door of the cargo vehicle is opened or closed. Here, the passive shaft (150) rotates in conjunction with the drive shaft (140) axially rotated by the driver (160). The passive shaft (150) is configured to protrude rearward of the cargo vehicle so that a volume loss of the loading space is minimized and connection to the other cargo vehicle is available.

The driver (160) provides the driving force in the first direction or in the second direction to the drive shaft (140). The driver (160) may be axially joined to the drive shaft (140) at the first stage of the base plate (110). The driver (160) may use a hydraulic motor, but is not necessarily limited thereto, and any drive motor capable of providing the driving force to the drive shaft (140) may be used. The driver (160) may move the drive shaft (140) to the upper part or to the lower part by a specific angle during a process of initially providing the driving force, and may provide a relatively strong driving rotational force. Here, the specific angle may be an angle of 10 degrees or smaller not to interfere with supporting the drive shaft (140).

A control unit (not shown) drives the driver (160) of the horizontal loading and unloading structure (100) of the cargo vehicle in accordance with an operation of a user through electrical connection, and provides the driving force in the first direction or in the second direction to the drive shaft (140) so that the drive chain belt (120) is operated to perform horizontal loading and unloading operations of the cargo.

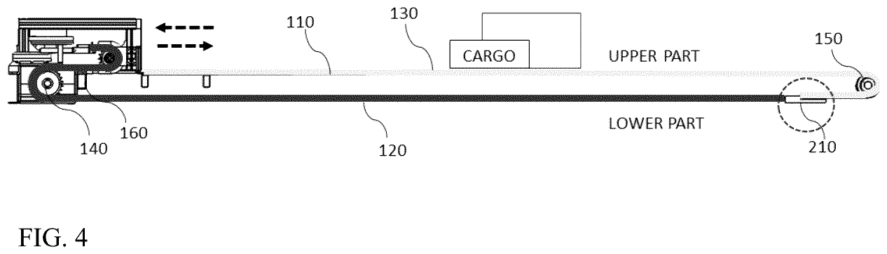

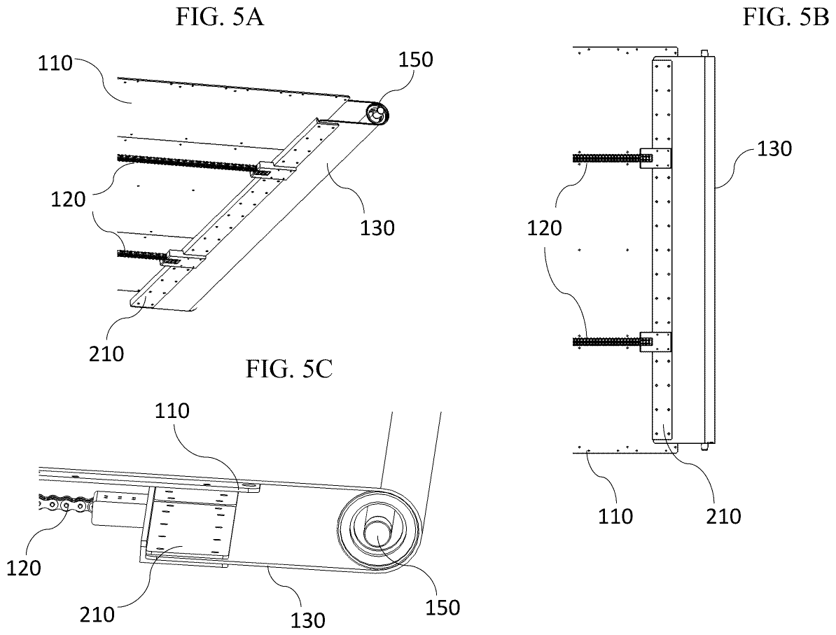

FIG. 4 is a diagram for describing a joining structure of the drive chain belt and the passive cover in FIG. 1, and FIGS. 5A-5C are diagrams showing a lower exposed portion to which the drive chain belt and the passive cover in FIG. 4 are connected.

Referring to FIG. 4 and FIGS. 5A-5C, the drive chain belt (120) is operated in such a manner that at least a portion is exposed to the upper part and at least another portion is exposed to the lower part on the base plate (110). The drive chain belt (120) is configured to include a plurality of chain belts, each of which is fastened in gear to the drive shaft (140). The drive chain belt (120) is joined to in gear to the drive shaft (140) at the first stage of the base plate (110). The drive chain belt (120) is operated in such a manner that at least a portion is always exposed to the upper part of the base plate (110) during a process of providing the driving force in the first direction or in the second direction from the driver (160).

The passive cover (130) is joined to the mutually separated chains in a lower exposed end of the drive chain belt (120) in a planar configuration. Here, the passive cover (130) may be joined to the lower exposed end of the drive chain belt (120) through the joining plate (210), as indicated by a dotted line in FIG. 3.

As shown in FIGS. 5A to 5C, the joining plate (210) is integrally formed in such a manner that the drive chain belt (120) and the passive cover (130) are fixed by an assembly element, welding, or the like in a state where the drive chain belt (120) and the passive cover (130) are joined. In one embodiment, the joining plate (210) may be joined to the drive chain belt (120) by welding, and may be joined to the passive cover (130) by bolt fastening. The joining plate (210) may be formed of a metal material to reinforce rigidity between the drive chain belt (120) and the passive cover (130). The joining plate (210) transmits the driving force of the driver (160) to the passive cover (130) through the drive shaft (140) and the drive chain belt (120) so that the passive cover (130) rotates and moves in accordance with the rotation of the drive chain belt (120).

The passive cover (130) is also operated in such a manner that at least a portion is exposed to the lower part and at least another portion is exposed to the upper part on the base plate (110). The passive cover (130) surrounds the base plate (110) together with the drive chain belt (120), and is configured to have a length of 80% to 120% of a length of the drive chain belt (120). The passive cover (130) is configured to have a structure that comes into direct contact with the cargo in the upper exposed portion. The passive cover (130) is closely joined to the passive shaft (150) at the second stage of the base plate (110).

In FIG. 4, a red line indicates the drive chain belt (120), and a yellow line indicates the passive cover (130). The lower plate of the bulkhead plate (170) is fixedly joined to the upper exposed portion to which the drive chain belt (120) and the passive cover (130) are connected. The bulkhead plate (170) horizontally moves inside the loading space of the cargo vehicle in conjunction with the passive cover (130). The bulkhead plate (170) loads or unloads the cargo on the passive cover (130) while horizontally moving.

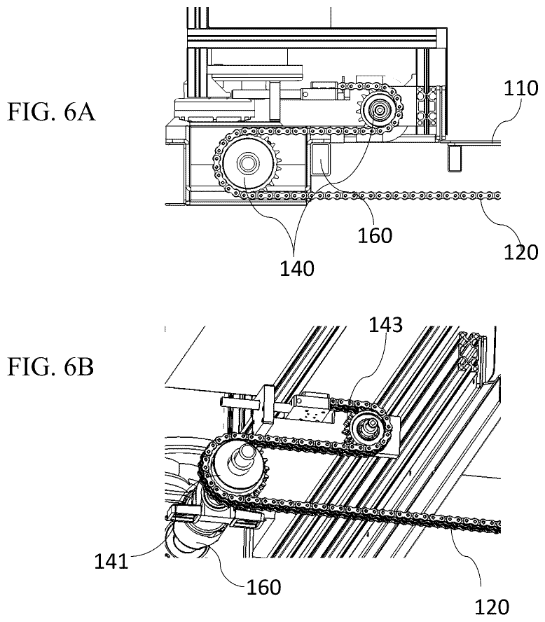

FIGS. 6A and 6B are diagrams showing a fastening state of the drive chain belt and the drive shaft in FIG. 1, where FIG. 6A is a side cross-sectional view and FIG. 6B is a bottom perspective view.

Referring to FIGS. 6A and 6B, the drive shaft (140) is joined in gear to the drive chain belt (120) at the first stage of the base plate (110). The first stage of the base plate (110) may be located inside a front surface of the loading space of the cargo vehicle. The drive shaft (140) forms the gear along a perimeter in a joining region of the drive chain belt (120). The drive shaft (140) may transmit the driving force of the driver (160) in the first direction to the upper part of the drive chain belt (120) during the loading process to operate the rotation of the upper part of the drive chain belt (120) so that the passive cover (130) moves toward the first stage of the base plate (110). The drive shaft (140) may transmit the driving force of the driver (160) in the second direction to the lower part of the drive chain belt (120) during the unloading process to operate the rotation of the lower part of the drive chain belt (120) so that the passive cover (130) moves toward the second stage of the base plate (110).

The drive shaft (140) may be located at the first stage of the base plate (110) which is a bottom surface of the loading space, and may provide the driving force to the drive chain belt (120) so that the passive cover (130) horizontally moves on the base plate (110). Here, the drive shaft (140) may be installed on a floor opposite to an entrance through which the cargo of the cargo vehicle is loaded and unloaded. In the drive shaft (140), the gears (141 and 143) are respectively disposed in the lower part and the upper part at the first stage of the base plate (110), and the drive chain belt (120) is interlocked and joined to the gears (141 and 143). The lower gear (141) is axially connected to the driver (160), and fulfills a role of transmitting the driving force in the first direction or in the second direction which is provided from the driver (160) to the upper gear (143) through the joined drive chain belt (120). The lower gear (141) of the drive shaft (140) axially rotates in the same direction as a driving direction of the driver (160) while the driver (160) is driven, and the upper gear (143) rotates in a direction opposite to a rotation direction of the lower gear (141). The upper gear (143) is rotated by the driving force in the first direction or in the second direction which is transmitted through the drive chain belt (120) to move the joined drive chain belt (120). In this case, the passive cover (130) joined to the drive chain belt (120) may perform horizontal loading and unloading operations in the loading space of the cargo vehicle by moving together along a moving direction of the drive chain belt (120). In this case, the bulkhead plate (170) joined to the upper exposed portion to which the drive chain belt (120) and the passive cover (130) are connected also moves in conjunction with the passive cover (130) along the moving direction of the drive chain belt (120).

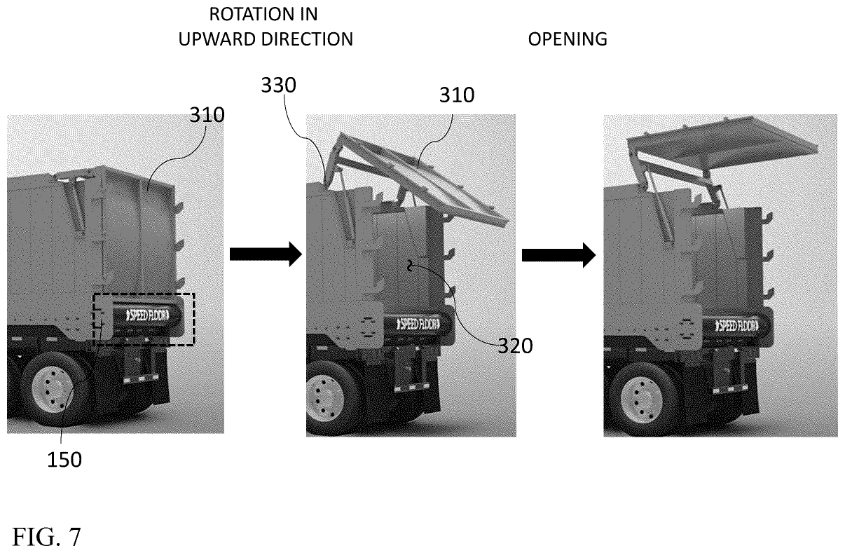

FIG. 7 is a diagram showing an embodiment of the cargo vehicle to which the horizontal loading and unloading structure according to the present disclosure is applied.

Referring to FIG. 7, the cargo vehicle includes the back door (310) that rotates upward and downward to open and close the loading space (320) in the entrance of the loading space (320). The back door (310) may be used to perform the loading process or the unloading process of the cargo by sealing the loading space (320) of the cargo vehicle and rotating in an upward direction to open the entrance.

The back door (310) may maximize the loading space (320) by exposing at least a portion of the passive shaft (150) outward of the rear surface of the loading space (320) and coming into contact with a specific point of the base plate (110) to form the loading space (320). The back door (310) may form a bending portion in the upper part, may rotate in the upward direction through the rotary shaft (330) joined to an end of the upper part to open the loading space (320), and may rotate in the downward direction to close the loading space (320). Here, the back door (310) may be formed in a shape bent in a substantially “L” shape.

In one embodiment, the back door (310) is joined and hinged by the rotary shaft (330), and may rotate in the upward direction or in the downward direction. A hydraulic device may be installed in the rotary shaft (330) so that the back door (310) is automatically opened and closed by length adjusting means which uses a hydraulic pressure generated from the hydraulic device to adjust the length.

The horizontal loading and unloading structure of the cargo vehicles according to the present disclosure which has this structure may be operated as follows.

### Loading Operation of Cargo Vehicle

First, the back door (310) rotates in the upward direction to open the loading space (320), and the cargo is loaded onto the passive cover (130) exposed on the base plate (110). During the loading process, the drive shaft (140) is axially rotated through the driver (160) to transmit the driving force in the first direction to the drive chain belt (120). The driver (160) moves the drive shaft (140) to the lower part by a specific angle during a process of initially providing the driving force so that a relatively strong driving rotational force is provided. The drive chain belt (120) is joined in gear to the drive shaft (140), and moves as the upper gear (143) is rotated by the driving force in the first direction to gradually move the passive cover (130) to the front surface of the loading space (320). The passive cover (130) may be always exposed to the upper part of the base plate (110) by moving to the front surface of the loading space (320) in a state where the cargo is loaded along the drive chain belt (120). That is, the passive cover (130) may come into direct contact with the cargo, and may move the cargo to the front surface of the loading space (320) to load the cargo so that the cargo is sequentially loaded from the front surface of the loading space (320). In this case, the bulkhead plate (170) fixedly joined to the upper exposed portion to which the drive chain belt (120) and the passive cover (130) are connected moves together with the passive cover (130) in accordance with the rotation of the drive chain belt (120), and supports the cargo loaded on the passive cover (130) so that the cargo is stably placed. When the loading operation of the cargo is completed, the driving of the driver (160) is stopped. Finally, the back door (310) rotates in the downward direction to close the loading space (320), and thereafter, a transport operation is performed.

### Unloading Operation of Cargo Vehicle

First, the back door (310) rotates in the upward direction to open the loading space (320) of the cargo vehicle, and the cargo loaded on the loading space (320) is unloaded. In the unloading process, the driving force in the second direction opposite to the first direction during the loading process is provided to the drive chain belt (120) through the driver (160). The passive cover (130) is joined to the upper exposed end and the lower exposed end of the drive chain belt (120), and the passive cover (130) is moved along the drive chain belt (120). The drive chain belt (120) may horizontally pull the passive cover (130) so that the cargo loaded on the passive cover (130) horizontally moves from the base plate (110) of the loading space (320). The drive shaft (140) may transmit the driving force of the driver (160) to the drive chain belt (120) to rotate the drive chain belt (120), and may horizontally move the passive cover (130) joined to the drive chain belt (120) so that the cargo placed on the upper part is discharged outward of the rear surface of the loading space (320). The drive chain belt (120) is rotated by the drive shaft (140) rotated in accordance with the rotation of the driver (160), and the passive cover (130) joined to the drive chain belt (120) moves to the lower part of the base plate (110) while being closely joined to the passive shaft (150) which is at least partially exposed outward of the rear surface of the loading space (320). That is, when the drive chain belt (120) rotates in the second direction in a state where the cargo is loaded on the upper exposed portion of the base plate (110), a pulling force is applied to the passive cover (130) joined to the drive chain belt (120) through the joining plate (210) so that the passive cover (130) horizontally moves outward of the rear surface of the loading space. In a process in which the passive cover (130) horizontally moves outward of the rear surface of the loading space, the bulkhead plate (170) moves together to support the cargo loaded on the upper part of the passive cover (130) so that the cargo does not fall toward the front surface of the loading space. The passive cover (130) is guided to move to the lower part of the base plate (110) by the passive shaft (150) which is at least partially exposed outward of the rear surface of the loading space, and the cargo is automatically discharged outward of the rear surface of the loading space. When the unloading operation of the cargo is completed, the drive chain belt (120) is rotated in the first direction through the driver (160) to apply the pulling force to the upper exposed end of the passive cover (130), and the passive cover (130) horizontally moves toward the front surface of the loading space (320). In a process in which the passive cover (130) horizontally moves toward the front surface of the loading space (320), the bulkhead plate (170) moves together to return to an original position inside the loading space (320).

Hitherto, the present disclosure has been described with reference to preferred embodiments. Meanwhile, it may be understood by those skilled in the art that the present disclosure may be corrected and modified in various ways within the scope not departing from the concept and the range of the present disclosure described in the appended claims.

### DESCRIPTION OF REFERENCE NUMERALS

100: horizontal loading and unloading structure of cargo vehicles
110: base plate
120: drive chain belt
130: passive cover
140: drive shaft
141: lower gear
143: upper gear
150: passive shaft
160: driver
170: bulkhead plate
180: chain belt guide
210: joining plate
310: back door
320: loading space
330: rotary shaft

What is claimed is:

1. A horizontal loading and unloading structure of cargo vehicles, comprising:
a base plate;
a drive chain belt configured to include mutually separated chains, at least a portion of which is always exposed to an upper part on the base plate;
a passive cover joined to both ends of the drive chain belt in a planar configuration, at least a portion of which is exposed to a lower part to surround the base plate together with the drive chain belt, and configured to have a length of 80% to 120% of a length of the drive chain belt;
a drive shaft joined to a gear of the drive chain belt at a first stage of the base plate, and transmitting a driving force in a first direction to an upper part of the drive chain belt during a loading process or transmitting the driving force in a second direction to a lower part of the drive chain belt during an unloading process;
a passive shaft closely joined to the passive cover at a second stage of the base plate, and passively operated in accordance with a movement of the passive cover; and
a driver providing the driving force in the first direction or in the second direction to the drive shaft.

2. The horizontal loading and unloading structure of cargo vehicle of claim 1, further comprising:
a back door that maximizes a loading space by exposing at least a portion of the passive shaft outward of a rear surface of the loading space and coming into contact with a specific point of the base plate to form the loading space.

3. The horizontal loading and unloading structure of cargo vehicle of claim 1, wherein the back door forms a bending portion in an upper part, rotates in an upward direction through a rotary shaft joined to an end of the upper part to open the loading space, and rotates in a downward direction to close the loading space.

4. The horizontal loading and unloading structure of cargo vehicle of claim 1, wherein the drive chain belt is configured to include a plurality of chain belts each engaged with the gear, is operated while at least a portion of the chain belts is always exposed to the upper part of the base plate during a process of providing the driving force in the first direction or in the second direction, and fixedly joins the bulkhead plate to an upper exposed portion connected to the passive cover.

5. The horizontal loading and unloading structure of cargo vehicle of claim 1, wherein the drive shaft forms the gear along a perimeter in a joining region of the drive chain belt, axially moves to the lower part during the loading process to transmit the driving force in the first direction to the upper part, and axially moves to the upper part during the unloading process to transmit the driving force in the second direction to the lower part.

6. The horizontal loading and unloading structure of cargo vehicle of claim 1, wherein the passive shaft is disposed outside the loading space of the cargo vehicle, and is exposed outward of the loading space regardless of whether the back door is opened or closed.

7. The horizontal loading and unloading structure of cargo vehicle of claim 1, wherein the driver moves the drive shaft to the upper part or to the lower part by a specific angle during a process of initially providing the driving force, and provides a relatively strong driving rotational force.

8. The horizontal loading and unloading structure of cargo vehicle of claim 1, further comprising:
a chain belt guide disposed along a movement path of the drive chain belt in a lower part of the base plate, and internally accommodating the drive chain belt to prevent sagging of the drive chain belt.
